(19) United States
(12) Patent Application Publication
(10) Pub. No.: US 2006/0157667 A1
(43) Pub. Date: Jul. 20, 2006

(54) Method and compositions for controlling release of organic compositions

(75) Inventors: Stephen A. Boyd, East Lansing, MI (US); Hui Li, East Lansing, MI (US); Brian J. Teppen, East Lansing, MI (US)

Correspondence Address: Ian C. McLeod;McLeod & Moyne, P.C., 2190 Commons Parkway, Okemos, MI, 48864, US

(73) Assignee: Board of Trustees of Michigan State University, East Lansing, MI (US)

(21) Appl. No.: 11/325,898

(22) Filed: Jan. 5, 2006

Related U.S. Application Data
(60) Provisional application No. 60/642,389, filed on Jan. 7, 2005.

(51) Int. Cl. A23J 7/00; C02F 1/72; B01J 20/00; F23C 1/00

(52) U.S. Cl. 252/1; 588/261; 502/400

(57) ABSTRACT

A method and compositions using layered clays with monovalent potassium, ammonium or cesium ions in the galleries of the clay which are also occupied by a preferably polar or semi polar organic compound. The method and compositions are particularly useful for controlled release of pesticides, insecticides, herbicides, fungicides, nematocides and contaminants in the presence of calcium or magnesium, or other naturally occurring inorganic cations as divalent displacement ions providing the release.

### CROSS-REFERENCE TO RELATED APPLICATIONS

This application claims priority to U.S. Provisional Application Ser. No. 60/642,389, filed Jan. 7, 2005.

### STATEMENT REGARDING GOVERNMENT RIGHTS

This invention was funded by USDA Grant No. 2003-35107-12899. The U.S. Government has certain rights to this invention.

### BACKGROUND OF THE INVENTION

1. Field of the Invention

The present invention relates to a method and compositions for controlling the release of an organic compound, which are preferably polar or semi-polar compounds, including pesticides, from clays with galleries occupied by potassium, cesium or ammonium ions or a mixture of the monovalent ions. The method is particularly useful for the release of pesticides into soils in the presence of divalent ions such as calcium, magnesium and other natural occurring ions.

2. Description of Related Art

It has been well established that the retention of nonpolar organic contaminants in soil-water systems is strongly correlated with soil organic matter (SOM) content, and that soil mineral fractions, predominantly calcium and magnesium, play a comparatively minor role except in the absence of water. SOM is viewed as providing a partition phase for the uptake of organic contaminants and pesticides (Chiou, C. T., et al., Science 206 831-832 (1979); Chiou, C. T., et al., Environ. Sci. Technol. 17, 227-231 (1983); Chiou, C. T., Partition and Adsorption of Organic Contaminants in Environmental Systems; John Wiley & Sons: Hoboken, N.J. (2002); Karickhoff, S. W., et al., Water Res. 13 241-248 (1979); Kile, D. E., et al., Environ. Sci. Technol. 29 1401-1406 (1995); Lyman, W. J., et al., Handbook of Chemical Property Estimation Methods: Environmental Behavior of Organic Compounds; American Chemical Society: Washington, D.C. (1990); Weber, W. J., et al., Environ. Sci. Technol. 30 881-888 (1996); Xia, G. S., et al., Environ. Sci. Technol. 33 262-269 (1999); and Xing, B., et al., Environ. Sci. Technol. 31 792-799 (1997)). The presence of natural and anthropogenic high-surface-area carbonaceous materials (HSACM, e.g., soots, humin, kerogen) in soils/sediments also contributes to a strong sorption of organic contaminants at low relative concentrations (Accardi-Dey, A., et al., Environ. Sci. Technol. 36 21-29 (2002); Braida, W. J., et al., Environ. Sci. Technol. 37 409-417 (2003); Bucheli, T. D., et al., Environ. Sci. Technol. 34, 5144-5151 (2000); Chiou, C. T., et al., Environ. Sci. Technol. 34, 1254-1258 (2000); Gustafsson, O., et al., Environ. Sci. Technol. 31, 203-209 (1997); Kleineidam, S., et al., Environ. Sci. Technol. 36, 4689-4697 (2002); Huang, W., et al., App. Geochem. 18, 955-972 (2003); and Yang, Y., et al., Environ. Sci. technol. 37, 3635-3639 (2003)). However, the HSACM materials are typically present in soils/sediments at low concentrations compared to the total SOM, hence, their overall contribution to sorption is low, especially at higher relative contaminant concentrations or in the presence of multiple solutes (Chiou, C. T., et al., Environ. Sci. Technol. 34, 1254-1258 (2000); and Cornelissen, G., et al., Environ. Sci. Technol. 38, 148-155 (2004)). The SOM-partition model appears valid for organic contaminants containing nonpolar or slightly polar functional groups (e.g., —Cl). It is however, frequently extended to organic contaminants in general, including those containing polar functional groups such as many pesticides. This is illustrated by the common use of soil-organic-matter (or carbon)-normalized sorption coefficients (K_{OM}, K_{OC}) to predict pesticide mobility in soils.

It is now clear that for important categories of pesticides (e.g., triazines, carbamates, ureas, nitrophenols) and organic contaminants (e.g., nitroaromatic compounds), sorption by clays may equal or exceed that by SOM, based on the estimates of sorption by the isolated sorbents (Sawhney, B. L., Clays Clay Miner. 45, 333-338 (1997); Sheng, G., et al., J. Agri. Food Chem. 49, 2899-2907 (2001); Sheng, G., et al., Clays Clay Miner. 50, 25-34 (2002); Laird, D. A., et al., Soil Sci. Soc. Am. J. 56, 62-67 (1992); Haderlein, S. B., et al., environ. Sci. technol. 30, 612-622 (1996); Boyd, S. A., et al., Environ. Sci. Technol. 35, 4227-4234 (2001); Li, H., et al., Soil Sci. Soc. Am. J., 67, 122-131 (2003) and Weissmahr, K. W., et al., Soil Sci. Soc. Am. J. 62, 369-378 (1998)). For example, Sheng et al. (2001) noted that K⁺-saturated smectite (i.e., SWy-2) was a more effective sorbent for pesticides such as 4,6-dinitro-o-cresol and 2,6-dichlobenil compared to sorption by an organic soil (Sheng, G., et al., J. Agri. Food Chem. 49, 2899-2907 (2001)). Furthermore, humic coatings on reference smectites (i.e., SWy-2 and SAz-1) did not significantly impact sorption and desorption of 4,6-dinitro-o-cresol and 2,6-dichlobenil by clay fractions for synthetic K⁺-saturated humic-smectite complexes with low organic carbon contents (<1.7%)(Li, H., et al., Soil Sci. Soc. Am. J. 67, 122-131 (2003)).

Pesticide adsorption by soil minerals is often dramatically influenced by the types of exchangeable cations commonly found in nature (Ca²⁺, Mg²⁺, Al³⁺, K⁺, NH₄⁺). These cations on clays control clay interlayer environments, and may interact with sorbed organic contaminants/pesticides, leading to greater adsorption (Sheng, G., et al., Clays Clay Miner. 50, 25-34 (2002); Haderlein, S. B., et al., Environ. Sci. Technol. 30; 612-622 (1996); Boyd, S. A., et al., Environ. Sci. Technol. 35, 4227-4234 (2001); Li, H., et al., soil Sci. Soc. Am. J., 67, 122-131 (2003); Weissmahr, K. W., et al., Soil Sci. Soc. Am. J., 62, 369-378 (1998); and Johnston, C. T., et al., Environ. Sci. Technol. 36, 5067-5074 (2002)). Among the common exchangeable cations in soils, K⁺-saturated clay minerals frequently demonstrate the strongest sorption of pesticides. This appears to be a manifestation of the comparatively weak hydration of K⁺. The enthalpy of hydration for K⁺ is −314 kJ/mol, smaller than that of Na⁺ (−397 kJ/mol) and much smaller than that of Ca²⁺ (−1580 kJ/mol) and Mg²⁺ (−1910 kJ/mol). Uncharged siloxane surfaces between charged sites on smectite surface are relatively hydrophobic and can interact with nonpolar moieties of organic contaminants when they are able to access these mineral surfaces (Laird, D. A., et al., Soil Sci. Soc. Am. J., 56, 62-67 (1992); Laird, D. A., et al., Environ. Toxicol. Chem. 18, 1668-1672 (1999); Boyd, S. A., et al., Layer Charge Characteristics of 2:1 Silicate Clay minerals, Clay Mineral Society: Boulder, Colo., 48-77 (1993); and Jaynes, W. F., et al., Clays Clay Miner. 39, 428-436 (1991)). However, when smectites are saturated with strongly hydrated divalent cations (e.g., Ca²⁺, Mg²⁺), the hydration sphere surrounding exchangeable cations diminishes the size of adsorptive domains between cations (Sheng, G., et al., Clays Clay Miner. 50, 25-34 (2002); Haderlein, S. G., et al., Environ. Sci. Technol. 30, 612-622 (1996); Weissmahr, K. W., et al., soil Sci. Soc. Am. J. 62, 369-378 (1998); and Weissmahr, K. W., et al., Environ. Sci. Technol. 31, 240-247 (1997)), and reduces the strength of interactions between exchangeable ions and polar functional groups in organic contaminants (Boyd, S. A., et al., Environ. Sci. Technol. 35, 4227-4234 (2001); Li, H., et al., Soil Sci. Soc. Am. J. 67, 122-131 (2003); Johnston, C. T., et al., Environ. Sc. Technol. 36, 5067-5074 (2002); and Johnston, C. T., et al., Environ. Sci. Technol. 35, 4767-4772 (2001)). Lastly, for K⁺-saturated smectites, the basal spacings are often observed at ˜12.3 Å, which appears optimal for adsorption or organic contaminants (Sheng, G., et al., Clays Clay Miner. 50, 25-34 (2002); and Boyd, S. A., et al., Environ. Sci. Technol. 35, 4227-4234 (2001)). This spacing is just large enough to allow intercalation of the sorbate (e.g., nitroaromatics), while minimizing its interaction with water molecules. This energetically favorable process occurs when the aromatic solute directly contacts the opposing clay siloxane surfaces. Larger interlayer spacings associated with Na⁺ or multivalent exchangeable cations do not allow the partial dehydration of organic solute in the clay interlayers (Sheng, G., et al., Clays Clay Miner. 50, 25-34 (2002); Boyd, S. A., et al., Environ. Sci. Technol. 35, 4227-4234 (2001); Li, H., et al., Soil Sci. Soc. Am. J. 67, 122-131 (2003); and Johnston, C. T., et al., Environ. Sc. Technol. 36, 5067-5074 (2002)).

Most previous studies on pesticide sorption by clays have been performed utilizing homoionic clays. Few studies have been conducted to examine sorption by clays with more than one type of exchangeable cation. Such mixed-cation clays are relevant to pesticide-mineral interactions in the soil environment where the presence of multiple types of exchangeable cations on clays is common. Weissmahr et al (1999) measured the adsorption of 4-nitrotoluene to the mixtures of homoionic K⁺-and Ca²⁺-saturated montmorillonite, and found that the adsorption did not increase linearly with fraction K-clay present (Weissmahr, K. W., et al., Environ. Sci. Technol. 34, 2593-2600 (1999)). Little change in adsorption was observed at the low fractional K⁺-clay contents (i.e., <0.2) and dramatically enhanced adsorption was found at fractional K-clay contents >0.4. No mechanistic explanation of these results was given.

Of interest are U.S. Pat. No. 5,667,694 to Cody et al; U.S. Pat. No. 5,730,996 to Beall et al; U.S. Pat. No. 5,955,094 to Beall et al; U.S. Pat. No. 6,020,282 to Taylor et al; U.S. Pat. No. 6,261,997 to Rubin et al; U.S. Pat. No. 6,458,343 to Zeman et al; U.S. Pat. No. 6,627,084 to Murphy et al and U.S. Pat. No. 6,664,213 to Furusawa et al. A number of these patents concern the use of organically modified clays as carriers for pesticides. In that art, the naturally occurring exchangeable cations (e.g. sodium) are replaced with organic cations to increase the affinity of the resultant organoclay for organic pesticide molecules. The patents of Beall et al utilize clays combined with various polymers or water miscible organic solvents to act as carriers for organic pesticide molecules. None of the patents describe the ability to control sustained release of the absorbed pesticide.

### Objects

There have been no studies on methods for the release of artificially absorbed pesticides into the environment. There is a significant need for the timed release of pesticides into an environment, particularly into soil in need of such treatment. There is also a need for the controlled absorption of contaminant organic compounds from a site. These and other objects will become increasingly apparent by reference to the following description.

### SUMMARY OF THE INVENTION

In the present invention, pesticide affinity are manipulated by using naturally occurring inorganic exchangeable cations. Cations like potassium or ammonium have low hydration energies and manifest high affinities for polar or semi polar pesticides and other organic molecules. Low hydration of these cations allows the pesticide molecule to interact with the cations and be held on the surfaces and within the interlayers of the clays. When such cations are replaced by inorganic cation with higher hydration energies (e.g. calcium) via simple ion exchange the interaction of the pesticide with the hydrated cation is comparatively less than with poorly hydrated cations. As a result, pesticide affinity for the clay diminishes and the pesticide molecules are released. Release occurs gradually as the ion exchange process (e.g. calcium replacing potassium or ammonium) continues. Since calcium is the most abundant naturally occurring exchangeable cation in many soils and subsoils, the aforementioned exchange process will occur gradually under natural conditions when potassium or ammonium clays with absorbed pesticides are added to soils. As the exchange process occurs the pesticides are released.

Thus the present invention relates to a method for providing release of an organic compound in an environment over time comprising water which comprises: applying in the environment containing calcium or magnesium ions, or other divalent cations along with the water, a modified clay with galleries between layers of the clay occupied by monovalent inorganic cations and the organic compound, wherein the monovalent cations in the galleries are selected from the group consisting of potassium, ammonium, cesium and mixtures thereof and wherein over time, the divalent cations in the environment cause displacement of the organic compound from the clay into the environment to provide the release of the organic compound into the environment. The controlled release can be of any polar or semi polar organic compound including a pesticide, insecticide, herbicide, pharmaceutical or contaminant.

The present invention also relates to a composition which comprises:

a modified clay with galleries between layers of the clay occupied by monovalent inorganic cations without organic anions and an organic compound, wherein the monovalent cations are selected from the group consisting of potassium, ammonium, cesium and mixtures thereof and wherein calcium, magnesium ions or other divalent cations along with water in an environment cause displacement of the organic compound from the clay into the environment over time to provide a release of the organic compound into the environment.

The present invention also relates to a method for providing release over time of an organic compound into soil which comprises applying in the soil a modified clay with galleries between layers of the clay occupied by monovalent inorganic cations, without organic anions, and the organic compound, wherein the cations are selected from the group consisting of potassium, ammonium, cesium and mixtures thereof and wherein over time, calcium, magnesium ions, or other divalent cations, present in the soil with water cause displacement of the organic compound from the clay into the soil to provide the release over time of the organic compound into the soil.

Preferably the polar organic compound is a pesticide. Preferably the pesticide is selected from the group consisting of herbicides, insecticides, fungicides, and nematocides.

The present invention also relates to a composition which comprises an organic compound selected from the group consisting of a pesticide, herbicide, insecticide, fungicides, nematocides, a pharmaceutical and a sorbed contaminant from a contaminated environment; and a modified layered clay with galleries between layers of the clay occupied by monovalent inorganic cations without organic anions and the organic compound, wherein the monovalent cations are selected from the group consisting of potassium, ammonium, cesium and mixtures thereof and wherein calcium or magnesium ions, or other divalent cations in an environment comprising water cause displacement of the organic compound from the clay to provide a release over time of the organic compound from the clay.

Preferably the organic compound is a pesticide. Preferably the pesticide is a polar or semi-polar organic compound. Preferably the clay is saturated with the monovalent cations. Preferably the clay is a potassium ion exchanged clay. Preferably the clay is a smectite clay. Preferably the organic compound is the contaminant which has been absorbed into the clay from the environment and then can be released into an aqueous solution containing calcium, magnesium or cesium ions, other divalent cations or mixtures thereof.

The present invention also relates to a method for decontaminating an environment comprising water and an unwanted organic compound and removing the unwanted compounds which comprises: exposing the unwanted organic compound to a modified clay with galleries between the layers occupied by a monovalent cation selected from the group consisting of potassium, ammonium, cesium and mixtures thereof so that the organic compound is sorbed into the modified clay to decontaminate the environment; collecting the modified clay with the sorbed organic compound from the environment; and introducing the sorbed organic compound from the modified clay into an aqueous solution containing calcium, magnesium, cesium or other divalent cations which cause the release of the organic compound into the aqueous solution to recover the organic compound. Preferably the environment is a soil. Preferably the organic compound is a pesticide. Preferably the clay is saturated with the monovalent inorganic cations. Preferably the clay is a potassium ion exchanged clay. Preferably the clay is a smectite clay.

Pesticides useful in the present invention include insecticides, herbicides, acaricides, growth regulators, rodenticides, defoliants, fungicides, larvacides, nematocides, repellents, and other compounds capable of repelling, mitigating, or destroying undesirable and objectionable plants and animals. Preferred pesticides are organic compounds having at least one polar moiety. Polarity of the moiety results from two adjacent atoms that are covalently bonded, wherein a first atom having a low electronegativity is bonded to a second atom having a higher electronegativity. The difference in electronegativity between the two atoms (e.g., preferably at least about 0.5 electronegativity units) creates a charge differential between the first and second atoms, i.e., polarity. The first atom of lower electronegativity generally has an electronegativity of at least 2, the second atom of higher electronegativity has an electronegativity preferably at least 0.5 electronegativity units greater than the first atom, and typically is an atom such as oxygen, sulfur, or nitrogen.

The polar moiety of the organic pesticide compound often is a carbonyl moiety, such as in a carboxylic acid or salt thereof, an ester, an amide, an anhydride, a ketone, or an aldehyde. However, the polar moiety also can be cyano, nitro, thiocarbamate, amino, carbamic, phosphate, thiophosphate, sulfoxide, carboximide, urea, sulfone, phosphorothioate, phosphorodithioate, thiourea, dithiocarbamate, phosphoramidodithioate, methylsulfonyl, phosphonate, sulfamide, phosphoramide, sulfonate, dithiocarbonate, hydroxyl, sulfate, sulfinate, sulfamate, or phosphinate moieties, for example. The polar moiety also can be other moieties containing a combination of sulfur and oxygen atoms, or a combination of phosphorus and oxygen atoms.

organic pesticide compounds containing one or more polar moieties are particularly suitable for use as intercalant pesticides in accordance with the present invention. However, pesticides lacking a polar group also can be used in the intercalant pesticide when an intercalant polymer is used to activate the layered material. The following are nonlimiting examples of pesticides useful in the present invention. The lists are intended to set forth examples of useful pesticides and are not intended to limit the pesticides that can be used in the present invention.

Fungicides

Allyl alcohol, anilazine, triadimenol, benomyl, benquinox, bunema, captafol, captan, carbendazim, carboxin, chinosol, chloroneb, chlorothalonil, cycloheximide, dazomet, dicloran, dichlofluanid, dichlone, dimethirimol, dinocap, manzeb, dithianon, dodemorph, dodine, drazoxolon, edinfenphos, fenaminosulf, fenapanil, fentiazon, ferbam, folpet, fongarid, guazatine, hymexazol, iprodione, kasugamycin, maneb, MEMC, methylthiophenate, metiram, nabam, neo-asozin, o-phenylphenol, PMA, oxycarboxin, parinol, PCNB, phosethyl, piperalin, polyoxin, procymidone, propineb, propazine, propionic acid, prothiocarb, pyracarbolid, pyrazophos, thiabendazole, thiophanate, thiram, tolylfluanid, triadimefon, tridemorph, triforine, triphenyltin acetate, validamycin A, vinclozolin, vondozeb, zineb, chloranil, ziram, 8-quinolinol, CDEC, metam, glyodin, 2,6-bis[dimethylaminomethyl]cyclohexanone, hexachloroacetone, bromoacetyl bromide, picloram, benalaxyl, blasticidin S, bupirimate, buthiobate, chinomethionate, chlozolinate, cymoxanil, cyproconazole, dithianon, ethirimol, etridazole, fenarimol, fenpiclonil, fenpropidin, fenpropimorph, fentin, flusilazole, flutriafol, flutolanl, fuberidazole, furalaxyl, imazalil, imibenconazole, iprobenphos, isoprothiolane, mancozeb, mepronil, methfuroxam, metsulfovax, myclobutanil, nuarimol, ofurace, oxadixyl, polyoxin B, polyoxin D, prochloraz, procymidone, propiconazole, pyroquilon, quintozene, tebucanazole, tetraconazole, triarimol, tricyclazole, triforine, and mixtures thereof, and in mixture with other pesticides. Salts and esters of these fungicides also can be used as the pesticide.

Herbicides

Acifluorfen, alachlor, alanap, alloxydim, ametryn, amitrol, asulam, atrazine, azide, barban, benazolin, benefin, bensulide, bentazone, benthiocarb, benzoylprop, benzthiazuron, bifenox, acetochlor, acrolein, benazolin, buthidazole, allidochlor, bromacil, bromofenoxin, bromoxynil, butachlor, butralin, buturon, butylate, chlometoxynil, chloramben, chlorbromuron, chlorfenprop, chloridazon, chlorotoluron, chloroxuron, chlorpropham, chlorthiamid, CNP, crotoxyphos, cycloate, cyprazine, 2,4-D, dalapon, 2,4-DB, DCPA, 2,4-DEP, desmedipham, 2,4-DP, desmetryn, diallate, dicamba, dichlobenil, dichlorprop, diethatyl, difenoxuron, diclofop, dimexano, dinitramine, dinoseb, dinoterb, diphenamid, dipropetryn, diquat, diuron, endothall, erbon, ethofumesate, fenac, fenuron, flamprop, fluchloralin, EPTC, pentachlorophenol, fluometuron, fluorodifen, flurecol, glyphosate, glyphosine, hexazinone, ioxynil, isopropalin, isoproturon, karbutilate, lenacil, linuron, MCPA, MCPB, mecoprop, medinoterb, methazole, methoprotryne, metobromuron, metolachlor, metoxuron, metribuzin, molinate, monalide, monlinuron, monuron, naptalam, neburon, nitralin, nitrofen, norea, norflurazon, oryzalin, oxadiazon, paraquat, pebulate, penoxalin, perfluidone, phenisopham, phenmedipham, picloram, procyazine, profluralin, prometon, prometryn, pronamide, propachlor, propanil, propazine, propham, secbumeton, siduron, silvex, simazine, swep, 2,4,5-T, 2,3,6-TBA, tebuthiuron, terbacil, terbumeton, terbuthylazine, terbutol, terbutryn, tetrafluoron, triallate, trietazine, trifluralin, vernolate, 1-naphthaleneacetic acid, N-m-tolylphthalamic acid, ethyl-1-naphthalene acetate, chloroacetic acid, trichloroacetic acid, p-chloromandelic acid, dimethylamino-2,3,5-triiodobenzoate, 2-naphthoxyacetic acid, phenoxyacetic acid, 2-phenoxypropionic acid, o-chlorophenoxy acetic acid, p-chlorophenoxy acetic acid, MCPA, silvex, MCPB, p-bromophenoxy acetic acid, dimethylamino-4 [2,4-dichlorophenoxy]butryate, 3-indolebutyric acid, 3-indoleacetic acid, 3-indolepropionic acid, gibberellic acid, N,N-dimethylsuccinamic acid, 2-furanacrylic acid, endothal, 1-naphthaleneacetamide, CDAA, N-methyl-N-1-naphthyl-acetamide, N-1-naphthyl acetamide, 2-[3-chlorophenoxy]propionamide, noruron, linuron, siduron, metobromuron, terbacil, chloroxuron, aminotriazole, cyanazine, chlorflurenol, chlorsulfuron, cyanazine, cyometrinil, 3,6-dichloropicolinic acid, dichlofop, difenzoquat, diphenamid, ethaflualin, ethepon, flurazole, flurenol, fluridone, fosamine, isouron, mefluidide, 1,8-naphthalic anhydride, napropamide, pyrazon, thoibencarb, anilazine, diphenatrile, N-[2,4-dichlorophenoxyl)acetyl-DL-methionine, daminozide, pyrazon, ethoxyquin, propham, EPTC, S-carboxymethyl-N,N-dimethyldicarbamate, phosphan, merphos, ethephon, tricamba, amiben, MCPD, glufosinate, indole-3-butyric acid, β-naphthoxyacetic acid, triclopyr, 9-undecylenic acid, oxyflurofen, dinitrocresol, flurtamone, diflufenican, difunon, fomesafen, clethodim, sethoxydim, haloxyfop, tralkoxydim, fenoxaprop, fluazifop, phaseolotoxin, rhizobitoxine, barban, ethephon, tetcyclacis, mepiquat chloride, ancymidol, uniconzaole, paclobutrazol, diquatop, pendimethalin, karbutilate, asulam, clopyralid, fluroxypyr, chlorimuron, chlorsulfuron, metsulfuron, buthidazole, imazamethabenz, imazapyr, imazaquin, imazethapry, isoxaben, cinmethylin, ethofumesate, and mixtures thereof, and in mixture with other pesticides. Several of the herbicides listed above are acid compounds. In addition to the acid form of such herbicides, esters (e.g., esters derived from C₁-C₁₂ alcohols) and salts (e.g., amine, potassium, lithium, and sodium salts) of these herbicides can be used as the intercalant pesticide.

Inscecticides and Acaricides

Acephate, aldicarb, aldoxycarb, aldrin, d-trans allethrin, allyxycarb, aminocarb, amitraz, azinphos, azinphos, azocyclotin, azothoate, bendiocarb, benzomate, binapacryl, bomyl, BPMC, bromophos, bromophos-ethyl, bromopropylate, butacarb, butocarboxim, chlordane, chlordecone, heptachlor, lindane, methoxychlor, toxaphene, butoxicarboxim, carbaryl, carbofuran, carbophenothion, cartap, chloridimeform, chlorfenethol, chlorfenvinphos, chlormephos, chlorobenzilate, chloropropylate, chlorphoxim, chlorpyrifos, chlorthiophos, coumaphos, CPMC, crufomate, cryolite, cyanofenphos, cyanophos, cyhexatin, cypermethrin, cythioate, DDT, DDVP, demeton, demeton-S-methyl, dialifor, diazinon, dicofol, dicrotophos, dieldrin, dienochlor, diflubenzuron, dimefox, dimethoate, dimethrin, dinobuton, dioxacarb, dioxathion, disulfoton, DNOC, d-phenothrin, endosulfan, enfrin, EPN, ethiofencarb, ethion, ethoate, ethoprop, etrimfos, famphur, fenbutatin-oxide, fenitrothion, fenson, fensulfothion, fenthion, fenvalerate. fonofos, formetanate hydrochloride, formothion, fosthietan, hydroprene, isofenphos, isoxathion, isothioate, malathion, mecarbam, mecarphon, menazon, meobal, mephosfolan, mercaptodimethur, methamidophos, methidathion, methomyl, methoprene, MIPC, mirex, monocrotophos, MTMC, naled, nicotine, omethoate, oxamyl, oxydemeton-methyl, oxydisulfoton, parathion, permethrin, phenthoate, phorate, phosalone, phosmet, phosphamidon, phoxim, pirimicarb, pirimiphos, plifenate, profenofos, promecarb, propargite, propetamphos, propoxur, prothiophos, prothoate, quinalphos, resmethrin, ronnel, ryania, salithion, schradan, sulfotepp, sulprofos, temephos, TEPP, terbuf os, tetrachlorvinphos, tetradifon, tetramethrin, tetrasul, thiocyclam-hydrogenoxalate, thiometon, thio-quinox, triazophos, trichloronate, trichloron, vamidothion, melvinphos, TEPP, trichlorofon, O,O-dimethyl phosphorochloriodothioate, methyl parathion, demeton O, dicapthon, O,O-diethylphosphorochloridothioate, propham, matacil, m[1-ethylpropyl]phenylmethylcarbamate & m[1-ethylpropyl] phenylmethylcarbamate (mixture), pyrethrum, benzyl thiocyanate, rotenone, eugenol, and mixtures thereof, and in mixture with other pesticides. Salts and esters of these insecticides also can be used as the intercalant pesticide.

Miscellaneous Pesticides

Aminozide, ancymidol, anthraquinone, brodifacoum, bromadiolone, butoxy polypropylene glycol, carbon tetrachloride, chloflurecol-methyl ester, chlormequat chloride, chlorophacinone, chloropicrin, chlorphonium, chlonitralid, coumachlor, coumafuryl, crimidine, cyoxmetril, deet, diazacosterol hydrochloride, dibutyl phthalate, ethyl hexanediol, dichlofenthion, difenacoum, dikegulac sodium, diphenylamine, ethephone, fenamiphos, fluoroacetamide, glyoxime, gossyplure, heliotropin acetal, kinoprene, maleic hydrazine, mepiquat-chloride, metaldehyde, metamsodium, naphthalene acetamide, 1-naphthaleneacetic acid, nitrapyrin, pyriminal, scillirosid, sesamex, sulfoxide, trifeninorph, triprene, warfarin, and mixtures thereof, and in mixture with other pesticides. Salts and esters of these pesticides also can be used as the intercalant pesticide.

Definitions

The term “environment” means an area which is being treated with an organic compound or where the organic compound is being removed. The environment can be a solution, a solid material or a mixture of solid materials and a solution as in soil.

The modified clays of the present invention can be removed after they have performed their function as is the case of bioremediation where pesticides are released into an environment such as soil where they can remain in place.

List of Clays

The smectite clays are 2:1 layered silicates, as well as those higher charge density analogs that function as cation exchangers. More specifically, the 2:1 layer silicates are selected from the group comprising montmorillonite, hectorite, fluorohectorite, saponite, beidellite, nontronite, stevensite, vermiculite, hydromicas, synthetic smectites, laponite, taneolite, and tetrasilicic mica, and the regularly ordered mixed layered clay rectorite. U.S. Pat. No. 5,993,769 to Pinnavaia et al describes ion exchanged clays in general.

### IN THE DRAWINGS

FIG. 1 is a graph showing sorption isotherms of dichlobenil by homoionic K—, Ca—SWy-2, and clay sorbents with varying K⁺/Ca²⁺ populations on mineral surface derived from homoionic K— and Ca—SWy-2. In particular, FIG. 1 shows molar fractions of potassium (f_{K}) derived by potassium and calcium combined versus amount of pesticide (dichlobenil) sorbed in a smectite clay. Sorption of the pesticide increases in the presence of non-potassium ions in the clay and decreases as the molar amount of calcium is increased.

FIG. 2 is a graph showing sorption isotherms of monuron by homoionic K—, Ca—SWy-2 and clay sorbents with varying K⁺/Ca²⁺ populations on mineral surface derived from homoionic K— and Ca—SWy-2.

FIG. 3 is a graph showing sorption isotherms of biphenyl by homoionic K—, Ca—SWy-2 and clay sorbents with varying K⁺/Ca²⁺ populations on mineral surface derived from homoionic Ca—SWy-2. In particular FIG. 3 shows pesticide, which is the non-polar pesticide biphenyl, adsorbed versus pesticide concentration for a potassium clay and for various potassium and calcium substituted clays.

FIG. 4 is a graph showing pesticide distribution coefficients normalized to sorption by K—SWy-2 at the aqueous relative concentration of 0.1 as a function of fractional K⁺-levels on mineral surface. The open symbols are the sorption in which K⁺ on homoionic K—SWy-2 was replaced by Ca⁺ and the solid symbols are the sorption in which Ca²⁺ on homoionic Ca—SWy-2 was replaced with K⁺ from aqueous solutions. In particular, FIG. 4 shows absorption coefficients of polar and non-polar clays as a function of potassium in the clay. The non-polar pesticide had no change as a function of potassium.

FIG. 5 is a graph showing X-ray diffraction patterns of oriented films of K—SWy-2, Ca—SWy-2 and the samples derived from homoionic K— and Ca—SWy-2 by K⁺/Ca²⁺ ion exchange. In particular, FIG. 5 shows low angle X-ray diffraction versus intensity.

### DESCRIPTION OF PREFERRED EMBODIMENTS

Preferably the clay is saturated with the cations. Most preferably the clay is an ion exchanged potassium clay. Preferably the clay is a smectite clay.

The magnitude of pesticide or organic contaminant sorption is proportional to the fraction of clay interlayers occupied by K⁺ (or NH₄⁺ or Cs⁺) ions. At the lower fractional K⁺-levels, K⁺ and other exchangeable cations appear to be randomly distributed within clay interlayers and the amount of K⁺ present may be insufficient to form K⁺-saturated domains. With increasing amounts of K⁺, individual clay interlayers can become K⁺-saturated due to the demixing of exchangeable cations (Verburg, K., et al., Clays Clay Miner. 43, 637-640 (1995); McBride, M. B., Environmental Chemistry of Soil; Oxford University Press: New York (1994); Levy, R., et al., Clays Clay Miner. 23, 475-476 1975); and Fink, D. H., et al., soil Sci. Soc. Am. Proc. 35, 113-117 (1971)), thereby creating strong sorptive domains for pesticide retention. In the following Examples, sorption isotherms of three pesticides of different polarities (dichlobenil, monouron, and biphenyl) were measured by a smectite clay (SWy-2) in which the cation exchange capacity was saturated by a range of fractional K⁺ and Ca²⁺ populations. The mixed-ion clays were produced by cation exchange starting with either homoionic K— or Ca—SWy-2. X-ray diffraction patterns of these clay samples were recorded to assess the effects of clay nanostructures on pesticide sorption.

Pesticide adsorption by soil clays can be dramatically influenced by the exchangeable cations present. Among the common exchangeable base cations in soils (Ca²⁺, Mg²⁺, K⁺, and Na⁺), K⁺-saturated clays frequently demonstrate the strongest affinity for pesticides. In the presence of multiple exchangeable cations in the system, we hypothesize that the magnitude of pesticide sorption to soil minerals is proportional to the fraction of clay interlayers saturated with K⁺ ions. To test this hypothesis, sorption of three pesticides with different polarities (dichlobenil, monuron, and biphenyl) were measured by homoionic K— and Ca—smectite (SWy-2) in KCl/CaCl₂ aqueous solutions. The presence of different amounts of KCl and CaCl₂ resulted in varying populations of K⁺ and Ca²⁺ on the clay exchange sites. The sorption of dichlobenil and, to a lesser extent monuron, increased with the fraction of K⁺ on clay mineral exchange sites. Ca— and K—SWy-2 displayed the same sorption capacities for nonpolar biphenyl. X-ray diffraction patterns indicated that at lower fractions of K⁺-saturation, exchangeable K⁺ ions were randomly distributed in clay interlayers, and did not enhance pesticide sorption. At higher populations of K⁺ (vs. Ca²⁺), demixing occurred causing some clay interlayers, regions or tactoids to become fully saturated by K⁺, manifesting greatly enhanced pesticide sorption. The forward and reverse cation exchange reactions influenced not only K⁺ and Ca²⁺ populations on clays, but also the nanostructures of clay quasicrystals in aqueous solution which plays an important, if not dominant, role in controlling the extent of pesticide sorption. Modulating the cation type and composition on clay mineral surfaces through cation exchange processes provides an environmental-safe protocol to manipulate the mobility and availability of polar pesticides, which could have applications for pesticide formulation and in environmental remediation.

### EXAMPLES

Among the clay minerals commonly found in soils, expandable 2:1 layer silicate clays are particularly important because of their wide distribution, high surface area and cation exchange capacity, as well as surface reactivity. A reference smectite clay (SWy-2, from the Source Clay Repository of Clay Mineral Society at Purdue University, West Lafayette, Ind.) that belongs to this group (Costanzo, P. M., Clays Clay Miner. 49, 372-373 (2001)) was chosen as a model sorbent. It has a cation exchange capacity of 820 mmol c/kg, and a surface area of 750 m²/g (van Olphen, H., et al., Data Handbook for Clay Minerals and Other Nonmetallic Minerals: Pergamon Press: N.Y., 19-27 (1979)). The <2 μm (e.s.d.) clay-sized fractions were obtained by wet sedimentation and subsequently exchanged with K⁺ by washing the clay-sized fraction with 0.5 M KCl solution three times. The excess KCl was removed by repeatedly washing with Milli-Q water until Cl⁻ was negatively determined by reacting with AgNO₃ solution. The clay suspensions were then quick-frozen, freeze-dried and stored in a closed container prior to use. The Ca²⁺-saturated SWy-2 (Ca—SWy-2) was prepared by exchanging the clay three times with 0.5 M CaCl2, removing the excess CaCl₂ by water washing followed by freeze-drying, as described above.

Dichlobenil (2,6-dichlorobenzonitrile, purity >97%), monuron (N′-(4-chlorophenyl)-N,N-dimethylurea, purity >99%) and biphenyl (1,1′-biphenyl, purity >99%) were purchased from Aldrich Chemical Company, Inc. (Milwaukee, Wis.), and used as received. Selected physicochemical properties of these pesticides and their chemical structures are given in Table 1.

TABLE 1
Table 1. Selected properties of pesticides investigated.

| | Molecular | Melting | Boiling | | |
|---|---|---|---|---|---|
| | Weight | Point | Point | S_{w} | |
| Pesticide | (g/mol)^{†} | (° C.)^{†} | (° C.)^{†} | (mg/L)^{†} | log K_{ow}^{†} |
| Dichlobenil | 172.02 | 144-145 | 270 | 25 | 2.90 |
| 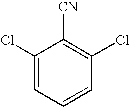 | | | | | |
| Monuron | 198.56 | 174-175 | — | 230 | 2.12 |
| 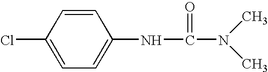 | | | | | |
| Biphenyl | 154.21 | 71 | 256 | 5.94-7.48 | 3.16-4.09 |
| 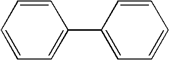 | | | | | |

^{†}Data from reference Montgomery, J. H., Agrochemicals Desk Reference, 2nd ed.; Lewis Publishers: Boca Raton: CRC Press (1997)

Calcium chloride dehydrate (>99%) and potassium chloride (>99%) used in this study were purchased from Mallinckrodt Baker, Inc. (Phillipsburg, N.J.).

Pesticide sorption from water solution by K— and Ca—SWy-2 mixed with different ratios of aqueous KCl to CaCl₂ (kept at a fixed ionic strength of 0.25 M) were measured using a batch equilibration method. A series of initial pesticide concentrations were prepared in the following electrolyte solutions: 0.25 M KCl, 0.24 M KCl/0.003 M CaCl₂; 0.20 M KCl/0.016 M CaCl₂; 0.15 M KCl/0.033 M CaCl₂; 0.10 M KCl/0.05 M CaCl₂; 0.05 M KCl/0.067 M CaCl₂; 0.01 M KCl/0.08 M CaCl₂; and 0.083 M CaCl₂. Clays were weighed into glass centrifuge tubes, solute solutions over a range of initial pesticide concentrations were added, and the tubes were closed with Teflon-lined screw caps. The tubes were then shaken reciprocally at 40 rpm for 24 h at room temperature (23±2° C.), followed by centrifugation at 2600 g for 30 min. Previous studies have shown that equilibrium was reached within this period of time (Sheng, G., et al., J. Agri. Food Chem. 49, 2899-2907 (2001); and Sheng, G., et al., Clays Clay Miner. 50, 25-34 (2002)). Supernatants were sampled and subject to analysis for pesticide concentrations using a Perkin-Elmer High Performance Liquid Chromatography (HPLC) system consisting of a Binary 250 LC pump, a Series 200 autosampler and a Series 200 UV-Visible detector. The optimal wavelength was set at 238 nm for dichlobenil, 250 nm for monuron and 248 nm for biphenyl. An Alltech platinum extended polar selectivity C18 column (15 cm by 4.6 mm i.d.) was used for dichlobenil and monuron, and an Alltech adsobosphere C18 column (25 cm by 4.6 mm i.d.) was used for biphenyl. The mobile phase composition was a mixture of methanol and water, and was optimized for each pesticide. Controls consisted of identical pesticide solutions in the corresponding electrolytes, but with no clay present. No changes in solute concentrations were detected in the tubes devoid of clay within the experimental period; therefore, solute mass lost in the supernatant from clay slurries was assumed to be sorbed by clay. The amount of pesticide sorbed was calculated from the difference between the initial and equilibrium solute concentration in aqueous solution.

After the supernatant sample was collected, approximately 2 mL of solution remained in the tubes with the clay. This mixture was resuspended, dropped on a glass slide, and air-dried to obtain oriented films for X-ray diffraction (XRD) analysis. XRD spectra of clay films were recorded using a Philips APD 3720 automated X-ray diffractionmeter equipped with Cu—Kα a radiation, an APD 3521 goniometer and a diffracted-beam monochromator. The scanning angle (2θ) ranged from 3 to 15° at steps of 0.02°, and the scanning time was 2 s per step.

The actual population of exchangeable K⁺ and Ca²⁺ associated with the clay was measured in a separate experiment using the BaCl₂ extraction method (Rhoades, J. D., Method of Soil Analysis part 2: Chemical and Microbiological Properties; 2^{nd} ed., American Society of Agronomy: Madison, Wis. 149-158 (1982)). The same amounts of clays and electrolyte solutions used in the sorption studies were added into glass centrifuge tubes, the tubes were shaken for 24 h at room temperature then centrifuged at 2600 g for 30 min. Aqueous supernatants were removed, diluted and analyzed by a Perkin-Elmer 3110 atomic absorption spectrophotometer (AAS). The mass of K⁺ and Ca²⁺ remaining in the residual supernatant was accounted for by assuming their concentrations to be the same as that measured in the bulk supernatant; residual supernatant that could not be removed was determined gravimetrically. The clay pellets were extracted three times using 0.1 M BaCl₂, then washed three times with Milli-Q water. The supernatants from the water washing were combined with the supernatants from the BaCl₂ extraction step, diluted and analyzed by AAS. The K⁺ and Ca²⁺ concentrations were measured using the external standards prepared with the matching matrix background of extraction reagents.

Results

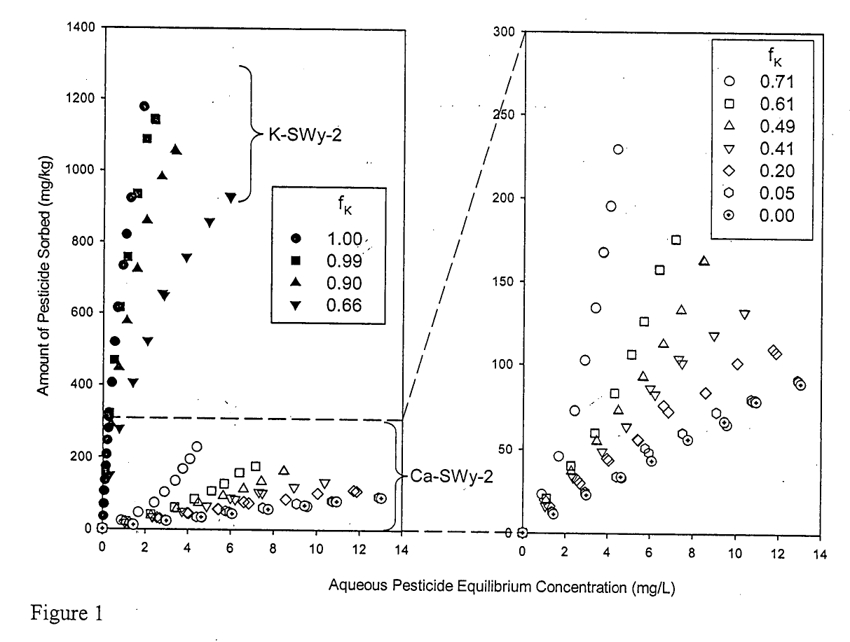

Sorption isotherms representing uptake of dichlobenil by K— and Ca—SWy-2 from aqueous solutions containing several KCl/CaCl₂ concentrations (kept at a fixed ionic strength of 0.25 M) are shown in FIG. 1. The lower portion of FIG. 1 was enlarged to more clearly illustrate sorption by Ca—SWy-2. Varying amounts of KCl/CaCl₂ in aqueous solution resulted in cation exchange (K⁺⇄Ca²⁺) with clays leading to different ratios of K⁺ to Ca²⁺ associated with the negatively charged cation exchange sites of SWy-2. The molar fractions of K⁺ (f_{K}, mol K⁺/mol (K⁺+Ca²⁺)) present on exchange sites were calculated based on the total extractable exchangeable cations, i.e. K⁺ and Ca²⁺. In general, dichlobenil sorption increased with increasing molar fraction of K⁺ on mineral surfaces for mixed-cation clays derived from either K—SWy-2 or Ca—SWy-2. However, when f_{K} values are comparable for the two systems (e.g., f_{K}=0.66 vs. 0.71 with K—SWy-2 and Ca—SWy-2 as the starting clays, respectively), much greater sorption was observed for sorbents derived from K—SWy-2 than from Ca—SWy-2.

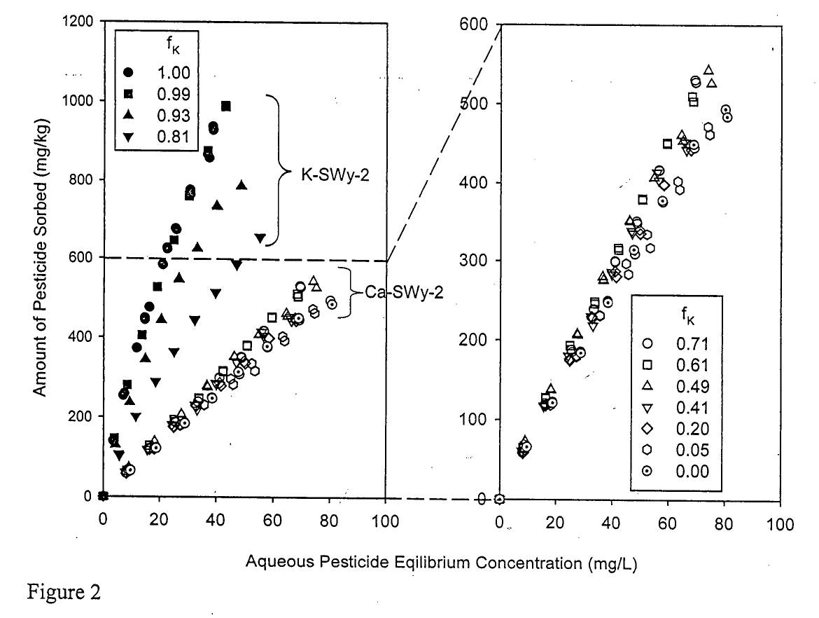

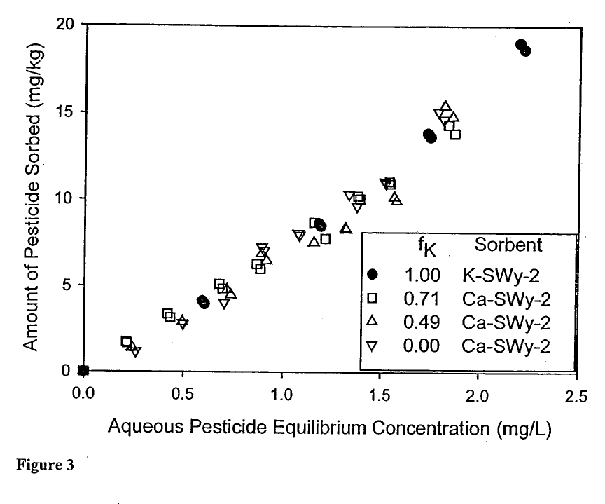

Sorbents derived from K—SWy-2 demonstrated increasing monuron sorption as molar fraction of K⁺ increased (FIG. 2), albeit to a lesser degree compared to sorption of dichlobenil. Sorption of monuron by Ca—SWy-2 derived sorbents, in which mineral-associated Ca²⁺ ions were replaced by K⁺ ions, was only slightly (ca. 205) enhanced even at f_{K} as high as 0.71. In this system, sorption enhancements observed as K⁺ replaced Ca²⁺ were more discernable at relatively higher aqueous equilibrium monuron concentrations. For the nonpolar pesticide biphenyl, sorption isotherms were essentially coincidental for all measured systems, i.e., those consisting of K—SWy-2 in KCl aqueous solution, Ca—SWy-2 in CaCl₂ background and in mixed-ion clays derived from Ca—SWy-2 (FIG. 3).

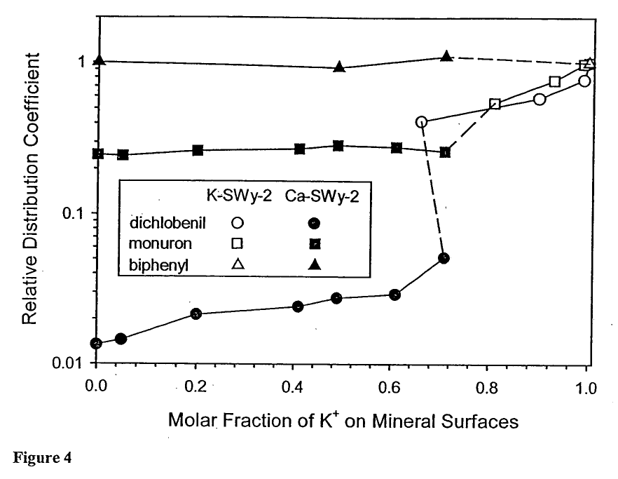

To further quantify the impact of the K⁺-saturated fractions on pesticide sorption enhancement by SWy-2, pesticide distribution coefficients were calculated at a relative concentration of 0.1 (aqueous equilibrium concentration/aqueous solubility) and normalized to the corresponding coefficients for sorption by homoionic K—SWy-2 in 0.25 M KCl solution (580 L/kg for dichlobenil, 27 L/kg for monuron and 6.4 L/kg for biphenyl) (FIG. 4). We compared sorption coefficients for clays derived from homoionic Ca—SWy-2 vs. those derived from homoionic K—SWy-2 after the homoionic clays had been treated with different amounts of CaCl₂/KCl aqueous solutions. Sorption of biphenyl remained nearly constant across the variation of K⁺ fractions on minerals from zero to one. No apparent enhancement at relative aqueous concentration of 0.1 was observed for monuron sorption on Ca—SWy-2 exchanged with KCl up to f_{K}=0.71, whereas when K—SWy-2 underwent exchange with CaCl₂, sorption was reduced by about half when the fraction K⁺-saturation decreased from 1 to 0.81. For dichlobenil, sorption by sorbents derived from Ca—SWy-2 increased by approximately four times as f_{K} increased from zero to 0.71. Replacement of K⁺ from K—SWy-2 by Ca²⁺ (from f_{K}=1 to 0.66) manifested gradually diminishing sorption of dichlobenil to ˜40% of that by homoionic K—SWy-2. Interestingly, dichlobenil sorption for clay derived from Ca—SWy-2 with f_{K}=0.71 is substantially (˜10×) lower than the corresponding clay derived from K—SWy-2 with f_{K}=0.66.

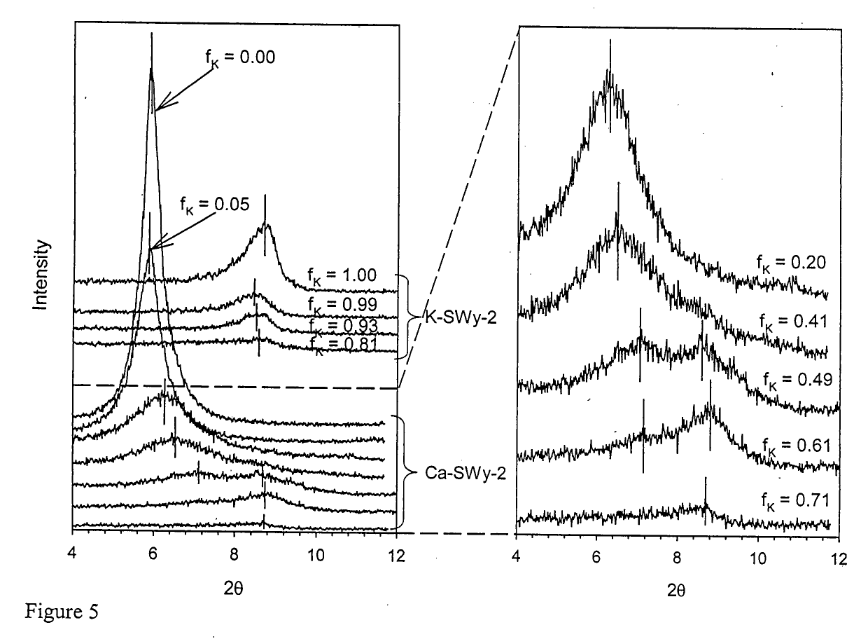

The XRD patterns for the air-dried clays used in the sorption experiments are shown in FIG. 5. The XRD pattern for the homoionic Ca—SWy-2 had a prominent 001 peak at 1.50 nm. Starting with the homoionic Ca—SWy-2, exchange with KCl (shown in the lower portion and the enlarged plot at the right side of FIG. 5) resulted in reduced peak intensities and shifts in peak positions. At lower K⁺-fractions, i.e., f_{K}=0.05, the intensity of the Ca—SWy-2 001 XRD peak substantially reduced but the 2θ position did not shift, indicating that the exchangeable K⁺ ions are randomly distributed in the predominately Ca-clay interlayers. At higher f_{K}=0.20 to 0.41, the peak intensity decreased further and the peak position shifted to higher values of 2θ, indicating that the size of the coherently diffracting domains decreased during cation exchange. These results suggest random interstratification of collapsed K-domains among the Ca-domains. This phenomenon is referred to as exchangeable cation demixing, wherein some clay platelets are occupied by K⁺ ions while other platelets remain Ca²⁺-saturated. More clay platelets were saturated by K⁺ in the presence of more KCl in solution. This is evidenced by the continuous shift of smectite diffraction peaks towards K—SWy-2 which was accompanied by a decreasing peak intensity. At higher f_{K} (0.49 to 0.71) an additional XRD peak appeared at a position consistent with homoionic K—SWy-2. This suggests the formation of fully K⁺-saturated regions and/or clay quasicrystals in addition to the Ca-saturated clay phase. The air-dried homoionic K—SWy-2 had a relatively low intensity 001 XRD peak at 1.03 nm. For clays derived from K—SWy-2, a significant reduction in the intensity of the diffraction peak and slightly lower 2θ values were noted between f_{K}=1 and 0.81, indicating that the samples were dominated by the 1.03 nm K-clay phase but the size of the coherently diffracting K-domains decreased. Presumably this arises from either deflocculation and consequent decrease in the size of K⁺-saturated colloids or else, i.e. random interstratification of expanded Ca-domains among the collapsed K-clay phase. In general and especially for f_{K}=0.5±0.2, the XRD evidence indicates that the K⁺ and Ca²⁺ were not homogeneously distributed on the exchange sites of the clay, but rather were demixed into separate K-dominated and Ca-dominated domains and phases.

Discussion

Exchangeable cations associated with clay minerals influence polar organic contaminant sorption by controlling interlayer distance, the size of sorptive domains, and the abilities of sorbate functional groups to interact with interlayer cations. Smectites saturated with weakly hydrated cations (e.g., K⁺) manifest a higher affinity for many polar pesticides compared to clays saturated with more strongly hydrated cations. Dichlobenil and monuron showed high affinity for clays derived from K—SWy-2 as evidenced by nonlinear sorption isotherms, which were concave to the abscissa, implying the development of specific interactions between sorbate molecules and sorbent. The comparatively low hydration enthalpy of K⁺ results in a smaller hydration sphere surrounding the exchangeable K⁺. This facilitates interactions of polar functional groups of the sorbate with K⁺ and/or polarized cation-bridging water molecules. It also results in less obscuration of clay surfaces between exchangeable cations, hence providing larger hydrophobic nano-sized siloxane domains for interacting with nonpolar pesticide moieties (Sheng, G., et al., Clays Clay Miner. 50, 25-34 (2002); Boyd, S. A., et al., Environ. Sci. Technol. 35, 4227-4234 (2001); Li, H., et al., Soil Sci. Soc. Am. J. 67, 122-131 (2003); Johnston, C. T., et al., Environ. Sci. Technol. 36, 5067-5074 (2002); and Johnston, C. T., et al., Environ. Sci. Technol. 35, 4767-4772 (2001)). Linear sorption isotherms and lower sorption were observed for dichlobenil on Ca—SWy-2 and its derived clays with low K⁺-contents (f_{K}<0.05), suggesting that the solute incompatibility with water was probably the primary driving force for pesticide retention by the Ca-phases.

At the relative aqueous concentration of 0.1, sorption by K—SWy-2 was approximately 75 times higher for dichlobenil, and 4 times higher for monuron than sorption by Ca—SWy-2. Such widely divergent affinities for K— vs. Ca—SWy-2 provides a simple way to modulate the extent of pesticide retention on smectite clays, i.e., by manipulating the relative amounts of exchangeable K⁺ and Ca²⁺ associated with clays. The sorption results presented in this invention clearly demonstrate that K⁺ and Ca²⁺ exchange on SWy-2 creates a range of K^{+/}Ca²⁺ populations, simultaneously manifesting an enhancement or reduction in sorption of dichlobenil and monuron (FIGS. 1 and 2). However, sorption is not a simple linear function of the fraction of exchange sites occupied by K⁺ (FIG. 4), but also depends strongly on the arrangements of K⁺ and Ca²⁺ in the interlayers, clay platelet orientation, and the interlayer environments arising from the cation exchange processes. For example, mixing homoionic Ca—SWy-2 with a KCl solution in which the K⁺ to Ca²⁺ ratio was 9.8 (including cations associated with minerals as well as present in solution) produced a fractional K⁺-level of f_{K}=0.71. This is lower than the K⁺-fraction (f_{K}=0.81) formed with a lesser amount of K⁺ present (K⁺/Ca²⁺=6.0) when proceeding in the reverse direction i.e., CaCl₂ mixed with homoionic K—SWy-2, and it is only slightly higher than the resultant f_{K}=0.66 with even less K⁺ present (K^{+/}/Ca²⁺=4.8). One phenomenon considered to control cation-exchange hysteresis is the tendency towards persistence of smectite interlayer spacings (Rhoades, J. D., Method of Soil Analysis part 2: Chemical and Microbiological Properties; 2^{nd} ed.; American Society of Agronomy: Madison, Wis., 149-158 (1982)). Owing to the hysteresis between the forward and reverse cation exchange reactions, the presence of more total K⁺ in the reaction where K⁺ replaces Ca²⁺ (with Ca—SWy-2) does not necessarily create a higher f_{K} value compared to the reverse reaction.

Mixed-ion clays with similar f_{K} values can display considerably greater or lesser pesticide affinity depending on the initial clay used, i.e. K—SWy-2 vs. Ca—SWy-2. For example, sorption of dichlobenil at f_{K}=0.66 in clay derived from homoionic K—SWy-2 is 8 times greater than the sorption of f_{K}=0.71 in clay derived from homoionic Ca—SWy-2. Different smectite interlayer spacings associated with K— vs. Ca-smectite demonstrate varying cation-exchange selectivity, resulting in cation-exchange hysteresis and preservation of the clay original structures (Laird, D. A., et al., Clays Clay miner. 45, 681-689 (1997)). Dichlobenil sorbs much more strongly to K-rather than Ca-saturated smectite minelayers (FIG. 1), so favorable sorption domains should be much more likely to persist at a given f_{K} when starting from the K-saturated end member. Weissmahr et al. (1999) did not observe such a significant sorption discrepancy at similar levels of K⁺-saturation possibly because they simply mixed Ca²⁺- and K⁺-homoionic montmorillonites when conducting sorption experiments (Weissmahr, K. W., et al., Environ. Sci. Technol. 34, 2593-2600 (1999)). Such mixing experimental procedure may have obviated significant alterations in clay structures that are critical determinants of adsorbent behavior (see discussion below).

The nanostructures of clay quasicrystals formed during cation exchange may play a major role in determining pesticide affinity. In aqueous solution, clay particles are usually present as quasicrystals consisting of stacks of several to hundreds of platelets (Laird, D. A., et al., Clays Clay miner. 45, 681-689 (1997)). The stacking of clay sheets in quasicrystals is broken down and reformed during cation exchange (Verburg, K., et al., Clays Clay Miner. 43, 637-640 (1995); Laird, D. A., et al., Clays Clay miner. 45, 681-689 (1997); and Verburg, K., et al., Soil Sci. Soc. Am. J. 59, 1268-1273 (1995)), in which the extent of breakdown depends on the type and composition of exchangeable cations present as well as the relative affinities of exchange cations for clay CEC sites. For the cation exchange of K⁺ replacing Ca²⁺ (from Ca—SWy-2), initially K⁺ ions tended to adsorb on the outer surfaces and edge sites of quasicrystals manifesting a reduced intensity of the XRD peak but no shift in its position (FIG. 5). Such a distribution of exchangeable cations did not create fully K⁺-saturated clay siloxane sheets or regions hence no major increase in pesticide sorption occurred. As the amount of K⁺ increased, it became sufficient to penetrate the interlamellar regions and replace Ca²⁺. During this process, the quasicrystal structures were partially broken down leading to greater dispersion of the resultant clay tactoids. Subsequently, some K⁺-saturated platelets collapsed to form K⁺-quasicrystals that manifest a shift of the XRD peaks toward the peak position of K—SWy-2 and/or the appearance of the characteristic K—SWy-2 peak. The intensity of the K—SWy-2 peak resulting from K⁺ exchange of Ca²⁺ was lower compared to that from homoionic K—SWy-2 even though the K⁺ molar fraction reached as high as f_{K}=0.71. This implies that many of the K⁺-saturated platelets remain dispersed, i.e., form K-quasicrystals of a few layers at most. Schramm and Kwak (1982) noted increased light transmission (at 650 nm) and viscosity of mixed Ca— and K-montmorillonite suspensions as the ratio of K-clay increased, and attributed these observations to the diminishing size of clay tactoids, i.e., a reduction in the number of platelets per tactoid (Schramm, L. L., et al., Clays Clay miner. 30, 40-48 (1982)). Similarly the present XRD data suggest the formation of smaller clay tactoids, as K⁺ replaced Ca²⁺ from Ca—SWy-2, resulting in less interlamellar (internal) surface. This manifests lower dichlobenil sorption compared to the case where a similar level of K⁺-saturation was reached from the opposite direction, i.e., starting with homoionic K- SWy-2.

For the ion exchange reaction of Ca²⁺ replacing K⁺ from K—SWy-2, Ca²⁺ must force the clay platelets open to replace K⁺. During this process the K-quasicrystals become somewhat less ordered and/or size-reduced as evidenced by a diminishing intensity of XRD peaks of K—SWy-2 with more CaCl₂ added. However, these tactoids still retain much of the basic nanostructures of the original homoionic K—SWy-2 (Laird, D. A., et al., Clays Clay Miner. 45, 681-689 (1997)), as indicated by no substantial shift of XRD peak position. Retention of this nanostructure appears to be an important determinant of clay affinity for aqueous-phase pesticides. This is illustrated by the observation that, at approximately equivalent levels of K⁺-saturation (˜70%), we observed significantly higher sorption of dichlobenil and monuron by clay derived from K—SWy-2 than by those derived from Ca—SWy-2.

It is of interest that there is a noticeable transition in isotherm shape for sorption of dichlobenil by clays derived from Ca—SWy-2 in the presence of different amounts of KCl/CaCl₂ (FIG. 1). Sorption isotherms for Ca—SWy-2 in CaCl₂ and low concentrations of KCl (0.01 M) were essentially linear. With more KCl present, the sorption isotherms changed from linear (C-type) to nonlinear (S-type) with curvature convex to the x-axis (pesticide aqueous concentration). A similar transition of isotherm shape was observed for 1,3-dinitrobenzene sorption by clays derived from Ca—SWy-2 in the presence of KCl solutions (our unpublished data). This S-type sorption isotherm implies that weak sorbate-sorbent interactions occur at low sorbate concentrations and that cooperative sorbate-sorbent interactions assist sorption at higher concentrations (Gregg, S. J., et al., Adsorption, Surface Area and Porosity; 2^{nd} ed.; Academic Press: London, (1982)). For dichlobenil, sorption displayed an upward S-type isotherm at f_{K} values between 0.49 to 0.71. The sorbed dichlobenil could interact with opposing K-clay platelets formerly present as loose structures formed during cation exchange. Dichlobenil sorption in this manner could promote the dispersed platelets to flocculate in a parallel orientation manifesting better-ordered quasicrystals. The creation of additional interlamellar surface area could then enhance pesticide uptake as evidenced by an upward deviation from the linear sorption isotherms. Such behavior is also implied by the observation that sorption of even small amounts of the pesticide 2,6-dinitro-o-cresol can inhibit K-smectite swelling (Sheng, G., et al., J. Agri. Food Chem. 49, 2899-2907 (2001)).

Use of Clays For Timed Release of Pesticides

Most research on the sorption of organic contaminants and pesticides has focused on soil organic matter as the primary sorptive domain, and ignored the contributions of soil mineral fractions. However, several recent studies have provoked interest in reassessing the role of soil minerals in the retention of organic contaminants, especially those containing polar functional groups (Sheng, G., et al., J. Agri. Food Chem. 49, 2899-2907 (2001; Sheng, G., et al., Clays Clay miner. 50, 25-34 (2002); Laird, D. A., et al., Soil Sci. Soc. Am. J. 56, 62-67 (1992); Haderlein, S. B., et al., Environ. Sci. Technol. 30, 612-622 (1996); Boyd, S. A., et al., Environ. Sc. Technol. 35, 4227-4234 (2001); Li, H., et al., Soil Sci. Soc. Am. J. 67, 122-131 (2003); Weissmahr, K. W., et al., Soil Sci. Soc. Am. J. 62, 369-378 (1998); Johnston, C. T., et al., Environ. Sci. Technol. 36, 5067-5074 (2002); Laird, D. A., et al., Environ. Toxicol. Chem. 18, 1668-1672 (1999); Boyd, S. A., et al., Layer Charge Characteristics of 2:1 Silicate Clay Minerals; Clay Mineral Society: Boulder, Colo. 48-77 (1993); Jaynes, W. F., et al., Clays Clay Miner. 39, 428-436 (1991); Weissmahr, K. W., et al., Environ. Sci. Technol. 31, 240-247 (1997); Johnston, C. T.; et al., Environ. Sci. Technol. 35, 4767-4772( 2001); and Weissmahr, K. W., et al., Environ. Sci. Technol. 34, 2593-2600 (1999)). For smectites, the type of exchangeable cation is the primary determinant of the size of sorptive domains in the clay galleries, clay interlayer distance and the ability to interact with polar functional group of organic contaminants. In the present invention, K⁺Ca²⁺-exchange on SWy-2 generates a wide range of K⁺-saturated fractions or domains in the clay, manifesting enhanced or reduced pesticide sorption. Thus simple ion exchange processes can be used in the development of an environmental-friendly protocol to control the sorption, mobility and bioavailability of polar pesticides, herbicides or insecticides or organic contaminants in smectite-containing soils or soils amended with smectite clays. The addition of simple electrolyte solutions can be used to manipulate the type and composition for exchange cations associated with clays, thereby modulating the release and immobilization of contaminants (Weissmahr, K. W., et al., Environ. Sci. Technol. 34, 2593-2600 (1999)).

There are several environmental applications of this approach, such as using K-clays as a carrier in pesticide, herbicide or insecticide formulations in order to extend the efficacious period by timed release. Pesticide is gradually released as Ca²⁺ and Mg²⁺ in soils gradually replaced K⁺ on the clay. Additionally, this simple geochemical control is useful in bioremediation/phytoremediation to modulate the sorption and hence bioavailability and toxicity of organic contaminants to microorganisms and plants. For example, reversible K-clay-facilitated stabilization/immobilization can permit establishment of a robust phytoremediative crop at otherwise phytotoxic contaminant levels, with subsequent Ca-induced release of contaminant into an active rhizosphere for biodegradation or plant uptake.

It is intended that the foregoing description be only illustrative of the present invention and that the present invention be limited only by the hereinafter appended claims.

We claim:

1. A method for providing release of an organic compound in an environment over time comprising water which comprises:
applying in the environment containing calcium or magnesium ions, or other divalent cations along with the water, a modified clay with galleries between layers of the clay occupied by monovalent inorganic cations and the organic compound, wherein the monovalent cations in the galleries are selected from the group consisting of potassium, ammonium, cesium and mixtures thereof and wherein over time, the divalent cations in the environment cause displacement of the organic compound from the clay into the environment to provide the release of the organic compound into the environment.

2. A composition which comprises:
a modified clay with galleries between layers of the clay occupied by monovalent inorganic cations without organic anions and an organic compound, wherein the monovalent cations are selected from the group consisting of potassium, ammonium, cesium and mixtures thereof and wherein calcium, magnesium ions or other divalent cations along with water in an environment cause displacement of the organic compound from the clay into the environment over time to provide a release of the organic compound into the environment.

3. A method for providing release over time of an organic compound into soil which comprises:
applying in the soil a modified clay with galleries between layers of the clay occupied by monovalent inorganic cations, without organic anions, and the organic compound, wherein the cations are selected from the group consisting of potassium, ammonium, cesium and mixtures thereof and wherein over time, calcium, magnesium ions, or other divalent cations, present in the soil with water cause displacement of the organic compound from the clay into the soil to provide the release over time of the organic compound into the soil.

4. The method of claim 3 wherein the organic compound is a pesticide.

5. The method of claim 4 wherein the pesticide is selected from the group consisting of insecticides, herbicides, fungicides, and nematocides.

6. The method of claim 3 wherein the clay is saturated with the monovalent cations.

7. The method of claim 3 or 4 wherein the clay is a potassium ion exchanged clay.

8. The method of claim 3 or 4 wherein the clay is a smectite clay.

9. A composition which comprises:
(a) an organic compound selected from the group consisting of a pesticide, herbicide, insecticide, fungicides, nematocides, a pharmaceutical and a sorbed contaminant from a contaminated environment; and
(b) a modified layered clay with galleries between layers of the clay occupied by monovalent inorganic cations without organic anions and the organic compound, wherein the monovalent cations are selected from the group consisting of potassium, ammonium, cesium and mixtures thereof and wherein calcium or magnesium ions, or other divalent cations in an environment comprising water cause displacement of the organic compound from the clay to provide a release over time of the organic compound from the clay.

10. The composition of claim 9 wherein the organic compound is a pesticide.

11. The composition of claim 10 wherein the pesticide is a polar or semi-polar organic compound.

12. The composition of claim 10 wherein the clay is saturated with the monovalent cations.

13. The composition of any one of claims 9, 10 or 11, wherein the clay is a potassium ion exchanged clay.

14. The composition of any one of claims 9, 10 or 11, wherein the clay is a smectite clay.

15. The composition of any one of claims 9, 10 or 11, wherein the organic compound is the contaminant which has been absorbed into the clay from the environment and then can be released into an aqueous solution containing calcium, magnesium or cesium ions, other divalent cations or mixtures thereof.

16. A method for decontaminating an environment comprising water and an unwanted organic compound and removing the unwanted compounds which comprises:
(a) exposing the unwanted organic compound to a modified clay with galleries between the layers occupied by a monovalent cation selected from the group consisting of potassium, ammonium, cesium and mixtures thereof so that the organic compound is sorbed into the modified clay to decontaminate the environment;
(b) collecting the modified clay with the sorbed organic compound from the environment; and
(c) introducing the sorbed organic compound from the modified clay into an aqueous solution containing calcium, magnesium, cesium or other divalent cations which cause the release of the organic compound into the aqueous solution to recover the organic compound.

17. The method of claim 16 wherein the environment is a soil.

18. The method of claims 16 or 17 wherein the organic compound is a pesticide.

19. The method of claims 16 or 17 wherein the clay is saturated with the monovalent inorganic cations.

20. The method of claims 16 or 17 wherein the clay is a potassium ion exchanged clay.

21. The method of claims 16 or 17 wherein the clay is a smectite clay.
